(19) United States
(12) Patent Application Publication
(10) Pub. No.: US 2007/0114396 A1
(43) Pub. Date: May 24, 2007

(54) Critical area calculation method and yield calculation method

(76) Inventor: Yoko Tohyama, Kyoto (JP)

Correspondence Address: MCDERMOTT WILL & EMERY LLP, 600 13TH STREET, N.W., WASHINGTON, DC, 20005-3096, US

(21) Appl. No.: 11/499,794

(22) Filed: Aug. 7, 2006

(30) Foreign Application Priority Data
Nov. 15, 2005 (JP) 2005-330232

(51) Int. Cl. G01N 23/00

(52) U.S. Cl. 250/307

(57) ABSTRACT

An effective critical area value of each circuit element of a target product is obtained on the basis of an effective critical area value per unit area or per unit capacity of each circuit element previously calculated and the area or capacity of each circuit element of the target product. The yield of the target product is calculated by using the effective critical area value of each circuit element of the target product, a defect density to be obtained on a fabrication line for the target product and a given yield model.

### BACKGROUND OF THE INVENTION

The present invention relates to a method for calculating a yield of semiconductor devices.

In the fabrication of semiconductor devices such as LSIs (large scale integrations), the cost of the semiconductor devices can be lowered by obtaining a large number of good LSIs from one semiconductor substrate (semiconductor wafer), namely, by improving the yield. The known factors for lowering the yield are, for example, defects such as particles causing short or open of interconnects or via formation failure in respective steps (particularly, a wiring step) of the LSI fabrication process. The density of defects such as particles can be estimated on the basis of, for example, dust distribution information of a clean room where the LSIs are fabricated. As the chip size of the LSIs is larger, the number of defects such as particles caused in one LSI chip is increased, and hence, the yield is lowered.

It is significant to calculate the yield of LSIs at the design stage for estimating the fabrication cost of the LSIs. Therefore, a yield model such as a Poisson model represented by the following Formula 1 or a negative binominal model represented by the following Formula 2 is used:
Y=exp(−Ac·D0) Formula 1
Y=(1+Ac·D0/α)^{(-α)} Formula 2
wherein Y is a yield, Ac is a critical area (cm²), D0 is a defect density (/cm²) and α is a coefficient corresponding to a clustering degree.

With respect to a yield of open/short of interconnects, a method using, for calculating the yield, a defect distribution curve and a critical area where a defect actually causes a failure has been proposed (see Non-patent document 1 below). A critical area is an index for quantitatively indicating the degree that a defect causes short or disconnection derived from open in the respective steps of the LSI fabrication process, and is equal to a sum of areas in which a defect actually causes a failure in a chip.

Methods for calculating such a critical area are roughly divided into two methods, that is, a method using graphic data processing (see, for example, Patent document 1 and Non-patent document 2 below) and a method using Monte Carlo simulation (see, for example, Patent documents 2 and 3 below).

In the method using graphic data processing, interconnect patterns are made thicker correspondingly to a radius of a particle, so as to define a portion where adjacent interconnects overlap as a critical area.

In the method using Monte Carlo simulation, with particles having random diameters generated, adjacent interconnects connected through such a particle are regarded as short, and a large number of such virtual particles are generated, so as to calculate a ratio of particles causing short among all the particles. A value thus calculated is approximate to a value obtained by normalizing a critical area by a chip area.

Also, a method for calculating a redundancy repair yield of an SRAM (static random access memory) or the like based on a result of critical area analysis has been disclosed (see Non-patent document 3 below).

Patent document 1: Japanese Laid-Open Patent Publication No. 2002-163323

Patent document 2: Japanese Laid-Open Patent Publication No. 2002-156418

Patent document 3: Japanese Laid-Open Patent Publication No. 2001-344301

Non-patent document 1: C. H. Stapper, Modeling of Integrated Circuit Defect Sensitivities, IBM J. Res. Develop., U.S.A., Nov. 1983, Vol. 27, pp. 549-557

Non-patent document 2: A. G. Allen et al., Efficient Critical Area Estimation for Arbitrary Defect Shapes, IEEE International Symposium on Defect and Fault Tolerance in VLSI Systems, Oct. 1997, pp. 20-28

Non-patent document 3: Jitendra Khare, Accurate Estimation of Defect-Related Yield Loss in Reconfigurable VLSI Circuits, IEEE Journal of Solid-state Circuits, U.S.A., Feb. 1993, Vol. 28, pp. 146-156

### SUMMARY OF THE INVENTION

The yield of semiconductor products can be accurately predicted by using any of the aforementioned yield prediction methods. However, the critical area analysis needs design data of products. Accordingly, although the yield should be accurately predicted before designing an actual product type, and specifically, for example, at a stage of examination of profitability or at a stage of determining redundancy repair performing conditions for SRAMs, any of the aforementioned methods cannot be employed because the layout data is not completed at such a stage. Therefore, before starting design of an actual product type, a method with low prediction accuracy, such as a method for predicting a yield based on a chip area or a method for determining a redundancy repair structure for an SRAM uniformly depending upon capacity, is conventionally employed.

The present invention was devised in consideration of the aforementioned conventional problem, and objects of the invention are providing a method for estimating a critical area, which is a necessary parameter for calculating a yield of given semiconductor device products, before starting actual design; and highly precisely predicting a yield attained at a desired stage of production before starting design of an actual product type of semiconductor devices by using the method.

In an actual semiconductor device product (including a plurality of kinds of circuit elements), the effective critical area values of circuit elements of the same kind are approximate to each other in accordance with the kind of the layout of the circuit elements, namely, the effective critical area values of the circuit elements of the same kind of layout are approximate to each other. Therefore, in order to achieve the objects, in the first critical area calculation method for yield prediction of this invention, a circuit TEG (test element group) or an already mass-produced product is subjected to the critical area analysis so as to obtain an effective critical area value per unit area or per unit capacity of each kind of circuit elements or each kind of processes, and the thus obtained effective critical area values are stored in a database. On the basis of the effective critical area value per unit area or per unit capacity thus obtained, an effective critical area of each circuit element of a target product is calculated.

Specifically, in the first critical area calculation method, with respect to a given process employed for the fabrication of the target product, the kinds of circuit elements are classified into an SRAM, a ROM (read only memory), a logic circuit, an analog circuit, an I/O region, an interconnect region and the like, and an effective critical area value per unit area or per unit capacity of each kind of circuit elements is stored in a database. At this point, with respect to a memory cell such as a ROM or an SRAM, an effective critical area value per unit capacity is preferably stored in the database, and with respect to a logic circuit, an analog circuit, an interconnect region and an I/O region, an effective critical area value per unit area is preferably stored in the database.

For obtaining such an effective critical area value per unit area or per unit capacity, if the analysis is performed during process development or device development, data obtained by subjecting actual GDS11 format data (layout data) of a development/evaluation circuit TEG to EDA (electronic design automation) processing may be used.

Alternatively, if there is another product type data whose design has already been completed, the existing data is classified into circuit elements such as a ROM, an SRAM, a logic circuit, an analog circuit, an I/O region, an interconnect region and the like, and resultant data of each circuit element is subjected to the critical area analysis through the EDA processing, so as to obtain an effective critical area value per unit area or per unit capacity.

In this manner, when the effective critical area values per unit area or per unit capacity of the respective circuit elements are previously stored in the database and the areas or the capacities of the respective circuit elements of the target product are estimated before starting the design, the effective critical area value of each circuit element of the target product (the product type of semiconductor devices to be novelly designed) can be estimated before completing the design on the basis of the values stored in the database (i.e., the effective critical area values per unit area or per unit capacity of the respective circuit elements) and the areas or capacities of the circuit elements of the target product. Accordingly, the yield of the target product attained, for example, at a stage of mass production can be predicted before starting the design of the product type or before completing the design data by using the effective critical area values of the respective circuit elements of the target product.

Furthermore, the second critical area calculation method for the yield prediction of this invention is applied to a semiconductor device product including a circuit for repairing a failure caused in a memory cell of an SRAM or the like. Specifically, in the second critical area calculation method, an average or a median of effective critical area values of a memory such as an SRAM is calculated previously with respect to each unit of redundancy repair correspondingly to a memory cell portion and a peripheral circuit portion. For example, in an SRAM, the redundancy repair is generally performed on each macro cell. As the effective critical area value of a memory cell portion (memory cell array portion), an effective critical area value per unit capacity is preferably used, and as the effective critical area value of a peripheral circuit portion, an effective critical area value per unit area is preferably used. When the thus obtained effective critical area values and a yield model formula are used, the yield of the memory cell array portion can be predicted separately with respect to a case where redundancy repair is performed on each macro cell and a case where it is not performed. At this point, the area of the peripheral circuit portion can be easily calculated on the basis of the bit number, the word number and the column number of the corresponding memory cell portion.

The yield of the target product attained at a desired stage (such as a stage of starting mass production) may be calculated correspondingly to respective memory cell redundancy repair conditions by using the effective critical area values of a ROM, a logic circuit, an analog circuit, an I/O region, an interconnect region and the like of an actual semiconductor device product, which are obtained by using the aforementioned critical area calculation method of the invention, the effective critical area values of respective units (for example, of respective macro cells) where the redundancy repair for an SRAM is performed, and the planned defect densities (planned D0 values) of respective layers to be attained in a plant in a time period when the redundancy memory effect is to be examined, such as time of the start of mass production or time for attaining the largest volume of production. Thus, the most advantageous redundancy repair condition, for example, an SRAM that can be actually redundancy repaired can be determined in consideration of the calculated yields of the target product corresponding to the respective redundancy repair conditions, test time cost derived from the addition of the redundancy repair process, cost for performing the redundancy repair process and influence on the chip area or the obtained chip number caused by providing a redundancy repair circuit to the target product.

Also, the redundancy repair condition determined in the aforementioned manner, the effective critical area values of the respective circuit elements of the target product and the planned D0 values (such as the D0 target values of each process to be attained in the mass production) can be used to calculate a yield attained for a given period of time (for example, several years) from the start of the mass production, so as to use the calculated yield for examining profitability and determining mass production schedule.

An effective critical area is herein defined as follows: The number of defects (particles) actually present is smaller as the particles are larger. When it is assumed that a particle has a size x and that the density (the number per unit area) of particles is indicated by D(x), that is, a function (defect distribution function) of the size x, it is experimentally known that D(x)∝x^{-p} (wherein p is a constant). Therefore, a product of this function D(x) and the above-described critical area Ac (which is expressed as Ac(x) because it is a function of the size x of the particles) is obtained, and a value integrated in a range not smaller than the minimum value of x is defined as the effective critical area value. In other words, the effective critical area =∫Ac(x)·D(x)dx, and the integration interval is from x0 (the minimum value of x) to the infinite. Also, the function D(x) is included in particle distribution information obtained on a fabrication line. When this effective critical area is defined, for example, as a critical area of one interconnect layer, the critical area of one interconnect layer can be expressed by one quantity, which can be easily dealt with.

According to this invention, a critical area value, which is a necessary parameter for calculating a yield of a given semiconductor device product, can be estimated before starting actual design. Also, when the critical area value is used, a yield of the target product attained at a desired stage (for example, a stage of mass production) can be highly precisely predicted before starting the design of an actual product type of semiconductor devices.

As described so far, the invention relates to a method for calculating a yield of semiconductor devices. Since the yield can be predicted before starting layout design and the predicted yield can be used for determining a memory cell redundancy repair condition or determining fabrication schedule, the present invention is very useful.

### BRIEF DESCRIPTION OF THE DRAWINGS

FIG. 1 is a flow chart of a critical area calculation method according to an embodiment of the invention and a yield calculation method and a redundancy repair condition determining method using the same;

FIG. 2 is a diagram of an example of layout data for use in the critical area calculation method of the embodiment;

FIG. 3 is a diagram of exemplified classification of the design data into circuit elements in the critical area calculation method of the embodiment;

FIG. 4 is a diagram for showing an exemplified plane structure of a 16-kbit SRAM separately including a memory cell array portion and a peripheral circuit portion;

FIG. 5 is a diagram for showing examples of effective critical area values per unit area or per unit capacity obtained for the respective circuit elements in the critical area calculation method of the embodiment;

FIG. 6 is a diagram of areas or capacities of circuit elements of a target product estimated in the critical area calculation method of the embodiment;

FIG. 7 is a diagram of effective critical area values of respective circuit elements and respective layers of a target product obtained by the critical area calculation method of the embodiment;

FIG. 8 is a diagram of examples of planned D0 values in a production projected plant for a target product for use in the yield calculation method of the embodiment;

FIG. 9 is a diagram for showing exemplified yields of a target product corresponding to respective redundancy repair conditions obtained by the yield calculation method of the embodiment;

FIG. 10 is a diagram for showing an exemplified result of profitability examination performed by using the yield calculation method of the embodiment; and

FIG. 11 is a diagram for showing an exemplified structure of a device used for practicing the critical area calculation method of the embodiment and the yield calculation method and the redundancy repair condition determining method using the same.

### DETAILED DESCRIPTION OF THE INVENTION

### EMBODIMENT

A critical area calculation method according to an embodiment of the invention, and a yield calculation method and a redundancy repair condition determining method using the same will now be described with reference to the accompanying drawings by exemplifying a product type of semiconductor devices having memory cells.

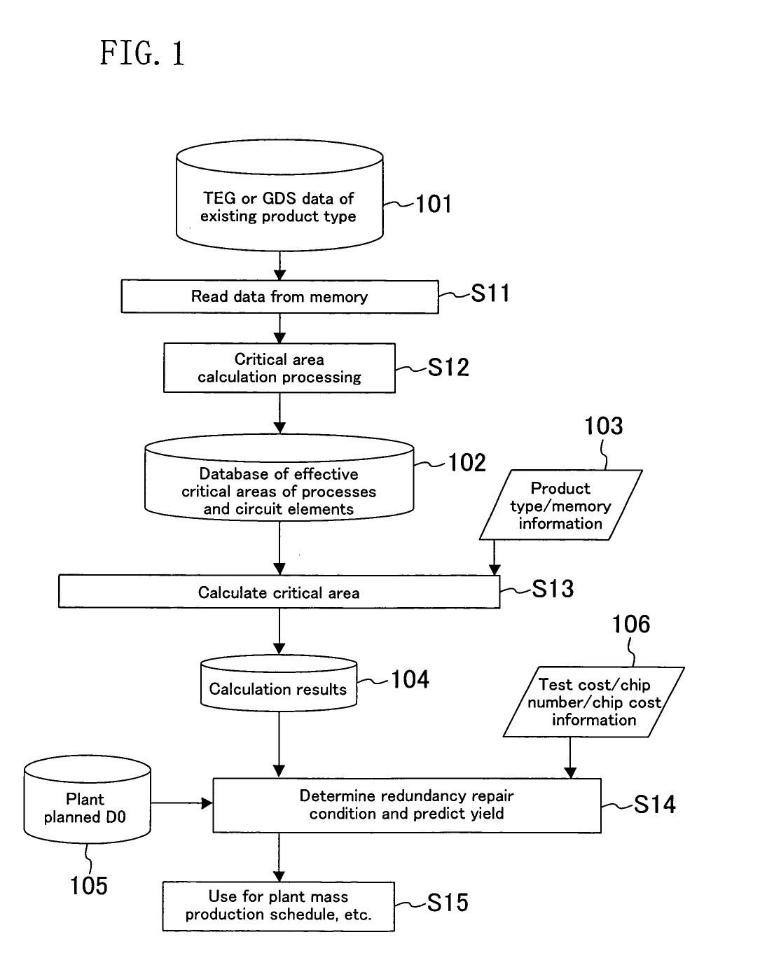

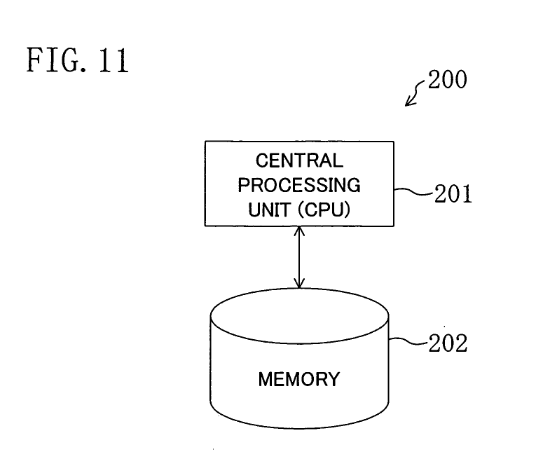

FIG. 1 is a process flow chart of this embodiment, and FIG. 11 is a diagram for showing an exemplified structure of a device used for practicing the process flow of FIG. 1. As shown in FIG. 11, the device 200 of this embodiment includes a central processing unit (CPU) 201 and a memory 202 for storing various data described below. The CPU 201 works as computing means for reading the various data from the memory 202 and executing respective processing (such as steps S11 through S15) of this embodiment described later by using the read data. Also, the CPU 201 works as outputting means for outputting calculation results obtained by executing the processing of this embodiment to the memory 202. It is noted that a program to be executed on the CPU 201 for performing the processing of this embodiment described below may be recorded in a recording medium.

Now, the method of this embodiment shown in FIG. 1 will be described in detail.

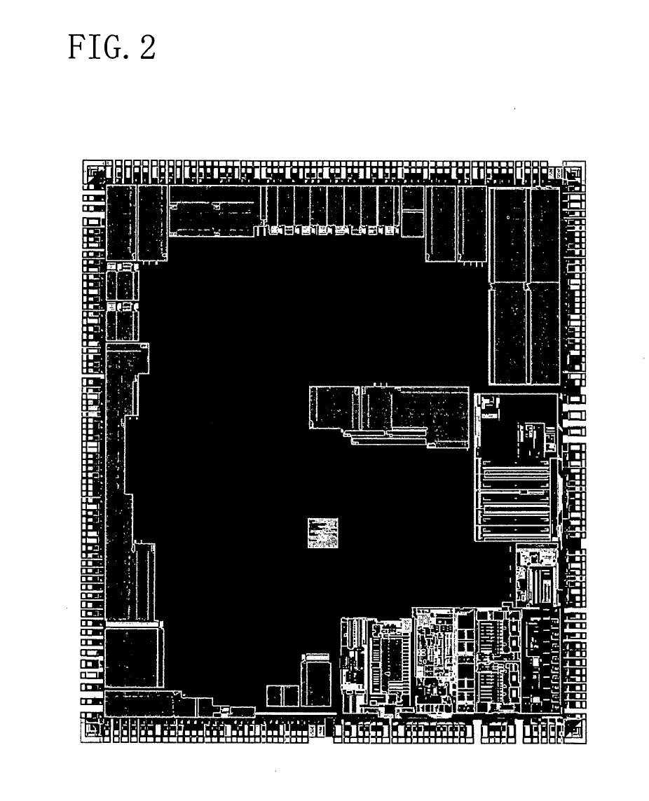

First, actual GDS11 format data (layout data) 101 of, for example, development/evaluation circuit TEG or other product types already designed is prepared to be stored in the memory 202. At this point, the layout data 101 of the TEG or the other product types as many as possible is preferably prepared. FIG. 2 shows an example of the layout data 101.

Next, in step S11 , the layout data 101 is read from the memory 202 as design data.

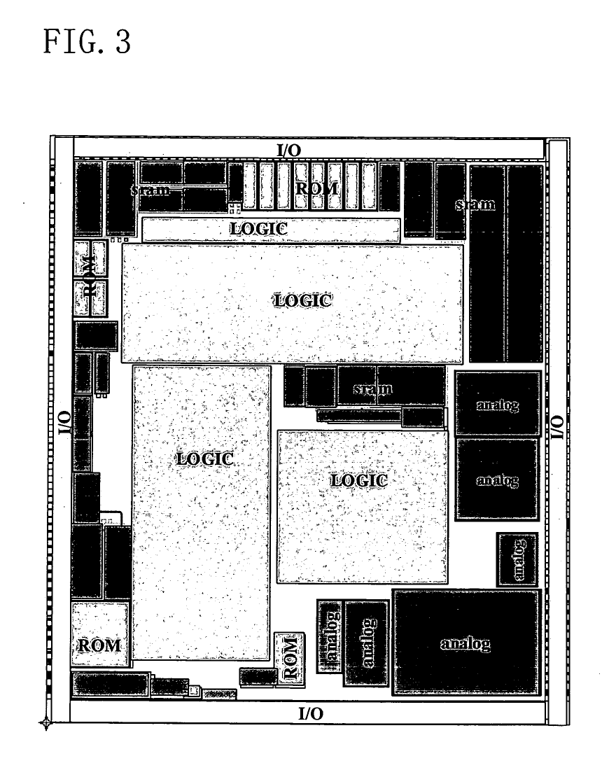

Then, in step S12, the design data read in step S11 is classified into an SRAM, a ROM, a logic circuit, an analog circuit, an I/O region, an interconnect region and the like. FIG. 3 shows an example of the classification of the design data of FIG. 2 into such circuit elements. Subsequently, design data classified into each circuit element is subjected to critical area analysis through EDA processing. At this point, the critical area analysis is performed by processing the actual layout data by using any of conventionally widely used Monte Carlo method and geometry method and an improved method of such a conventional method. When the result of the critical area analysis and a defect distribution curve peculiar to each process are used, values influenced by characteristics of the respective circuit elements, such as a value of 0.00056 for a logic circuit, 0.00001 for an analog circuit and 0.000008 for an I/O region, are obtained as effective critical area values per unit area with respect to gate open occurring in a process of a given generation. Also, values influenced by the circuit elements can be obtained similarly with respect to an OD region (a diffusion region) and an interconnect region.

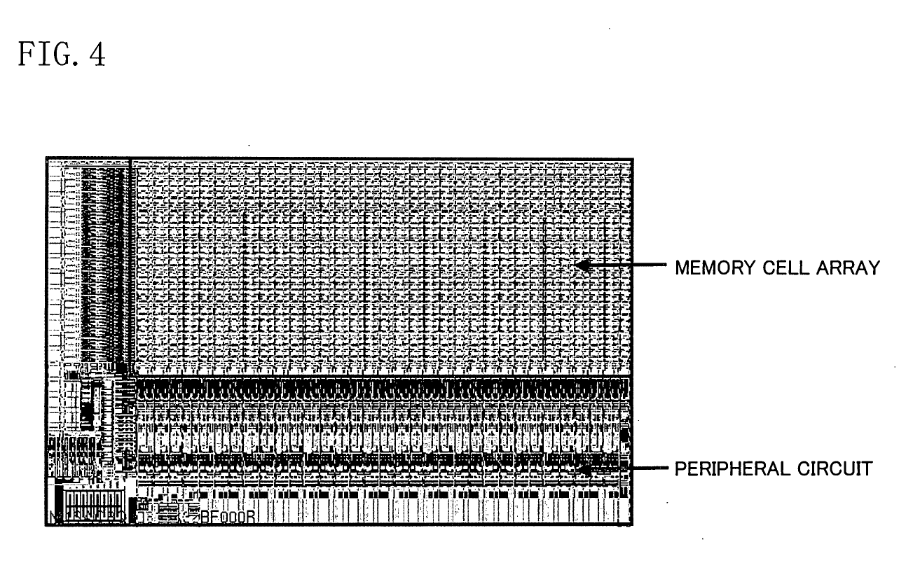

In step S12, after obtaining effective critical area values of the respective circuit elements in all layers related to yield calculation of the target product, each effective critical area value is converted into a value per unit area or per unit capacity, and an average or a median of values obtained with respect to each process (which is determined in accordance with the target product) and each circuit element is stored as a typical value in a database 102 on the memory 202. At this point, with respect to a memory cell such as a ROM or an SRAM, an effective critical area value per unit capacity is preferably stored in the database, and with respect to a logic circuit, an analog circuit, an interconnect region and an I/O region, an effective critical area value per unit area is preferably stored in the database. Also, with respect to a memory that can be subjected to redundancy repair such as an SRAM, effective critical area values of a memory cell portion and a peripheral circuit portion are calculated previously separately in each unit of redundancy repair (for example, in each macro cell). FIG. 4 shows an exemplified structure of a 16-kbit SRAM separately including a memory cell array portion and a peripheral circuit portion.

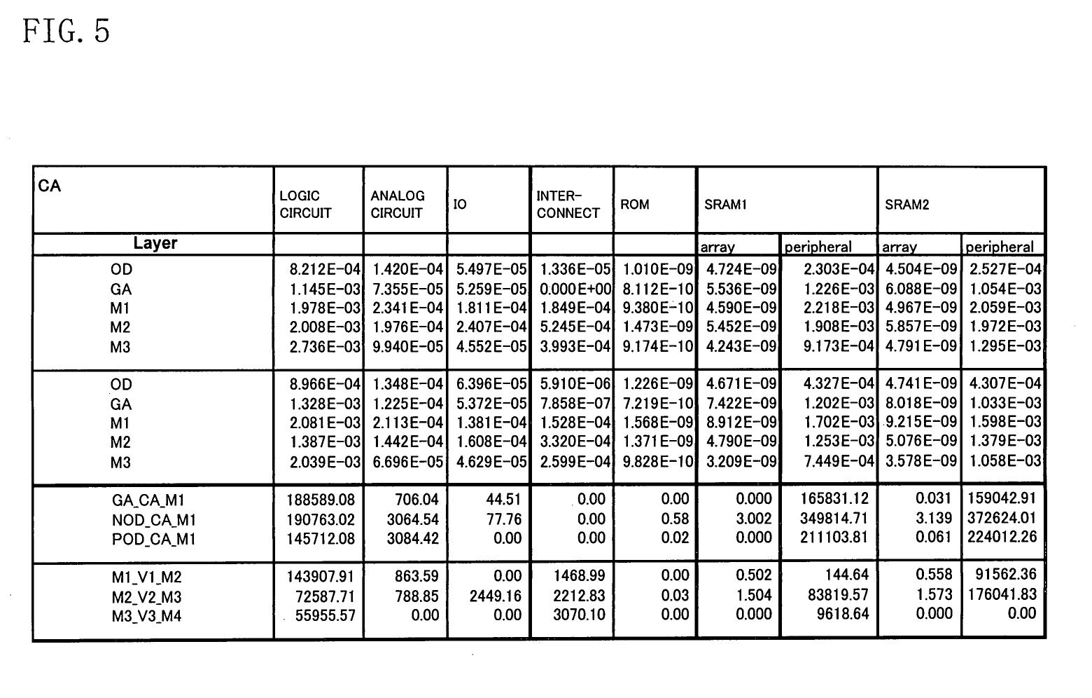

It is noted that an effective critical area value per unit capacity is preferably calculated with respect to the memory cell array portion and that an effective critical area value per unit area is preferably calculated with respect to the peripheral circuit portion. FIG. 5 shows examples of the effective critical area values per unit area or per unit capacity obtained for the respective circuit elements. In FIG. 5, “CA” indicates a critical area, “array” indicates a memory cell array portion, “peripheral” indicates a peripheral circuit portion, “OD” indicates an active region, “GA” indicates a gate electrode, “M” indicates an interconnect layer, “NOD” indicates an active region of an N-type MIS (metal insulator semiconductor) transistor, “POD” indicates an active region of a P-type MIS transistor and “V” indicates a via.

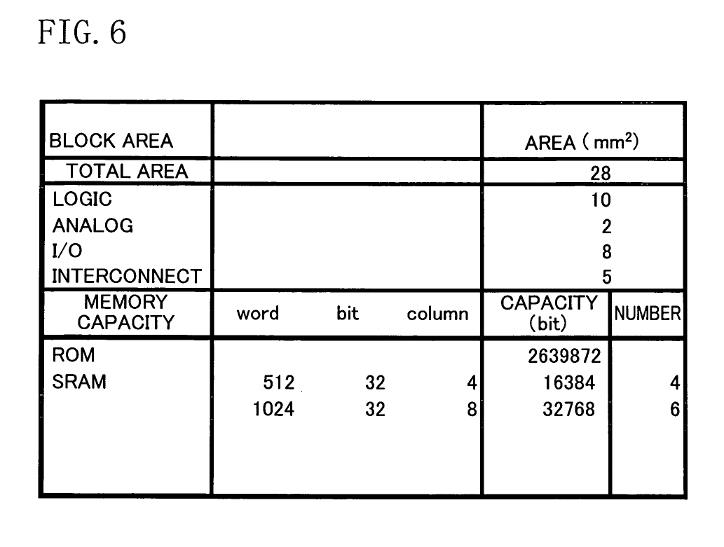

Next, in this embodiment, before starting design of the product type (target product), the areas or the capacities of respective circuit elements of the product type are estimated, and estimated results are stored in the memory 202 as product type/memory information 103. FIG. 6 shows an example of the product type/memory information 103. As shown in FIG. 6, the total area of the target product is 28 mm², the area of logic circuits is 10 mm², the area of analog circuits is 2 mm², the area of I/O regions is 8 mm², and the area of interconnect regions is 5 mm². Also, the total capacity of ROMs is 2639872 bits. Furthermore, with respect to SRAMs, all the structural conditions of the SRAMs are listed up for examining the redundancy repair effect. Specifically, there are four SRAMs (with capacity of 16384 bits) each with 512 words, 32 bits and 4 columns and six SRAMs (with capacity of 32768 bits) each with 1024 words, 32 bits and 8 columns.

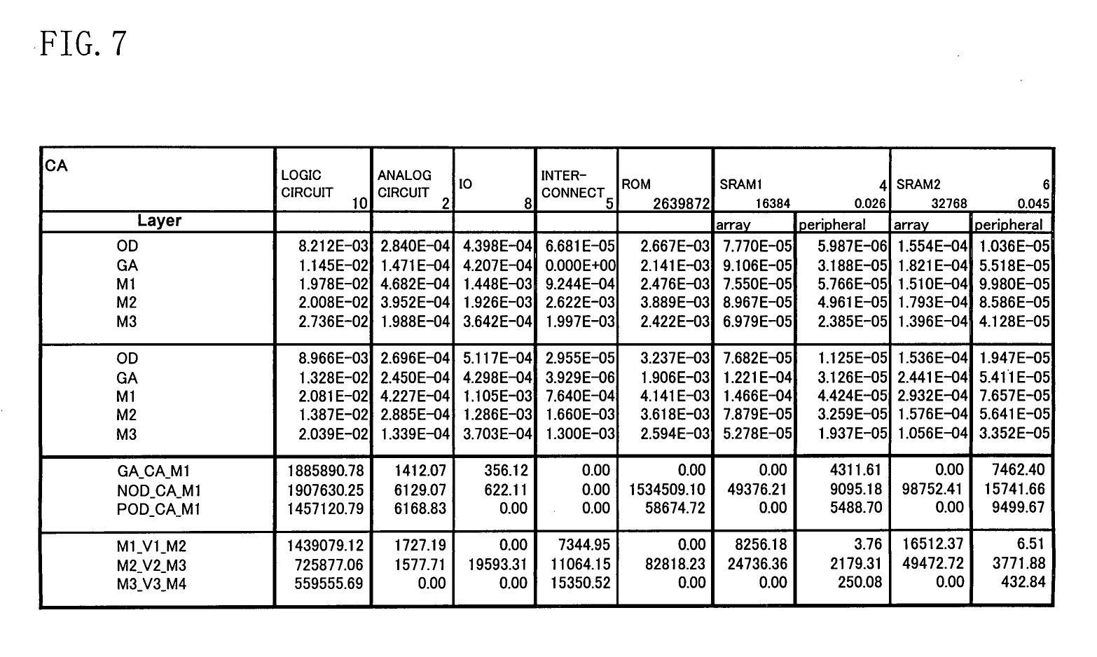

Next, in step S13, the product type/memory information 103, namely, the areas or the capacities of the respective circuit elements of the target product, and the effective critical area values (obtained in employing the process applied to the target product) per unit area or per unit capacity of the respective circuit elements stored in the database 102 are used to calculate effective critical area values of the respective circuit elements and the respective layers of the target product (specifically, an actual product type of semiconductor devices to be designed), and the thus obtained calculation result 104 is stored in the memory 202. FIG. 7 shows an example of the calculation result 104. In FIG. 7, “CA” indicates a critical area, “array” indicates a memory cell array portion, “peripheral” indicates a peripheral circuit portion, “OD” indicates an active region, “GA” indicates a gate electrode, “M” indicates an interconnect layer, “NOD” indicates an active region of an N-type MIS transistor, “POD” indicates an active region of a P-type MIS transistor and “V” indicates a via. Furthermore, FIG. 7 also shows the areas (in mm²) with respect to a logic circuit, an analog circuit, an interconnect region and an I/O region, the total capacity (in bits) with respect to a ROM, the number with respect to SRAMs, the capacity (in bits) with respect to a memory cell array portion of an SRAM and the area with respect to a peripheral circuit portion of an SRAM.

Next, in step S14, the calculation result 104, namely, the effective critical area values of the respective circuit elements and the respective layers of the target product, a defect density (for example, a defect density to be attained in planned mass production) and a defect distribution function to be obtained on a production line of the target product previously calculated and a yield model formula such as the Poisson model are used to calculate the yield of semiconductor devices of the target product.

In the case where the target product is or includes a memory such as an SRAM and has a memory cell macro including a memory cell portion, a peripheral circuit portion and a redundancy repairing circuit portion for repairing a failure caused in the memory cell portion, the effective critical area values of the respective circuit elements of the target product are calculated at least separately with respect to the memory cell portion and the peripheral circuit portion in step S13. Furthermore, on the basis of the thus calculated effective critical area values, the yield of the memory cell macro is obtained separately with respect to a case where the redundancy repair is performed and a case where it is not performed.

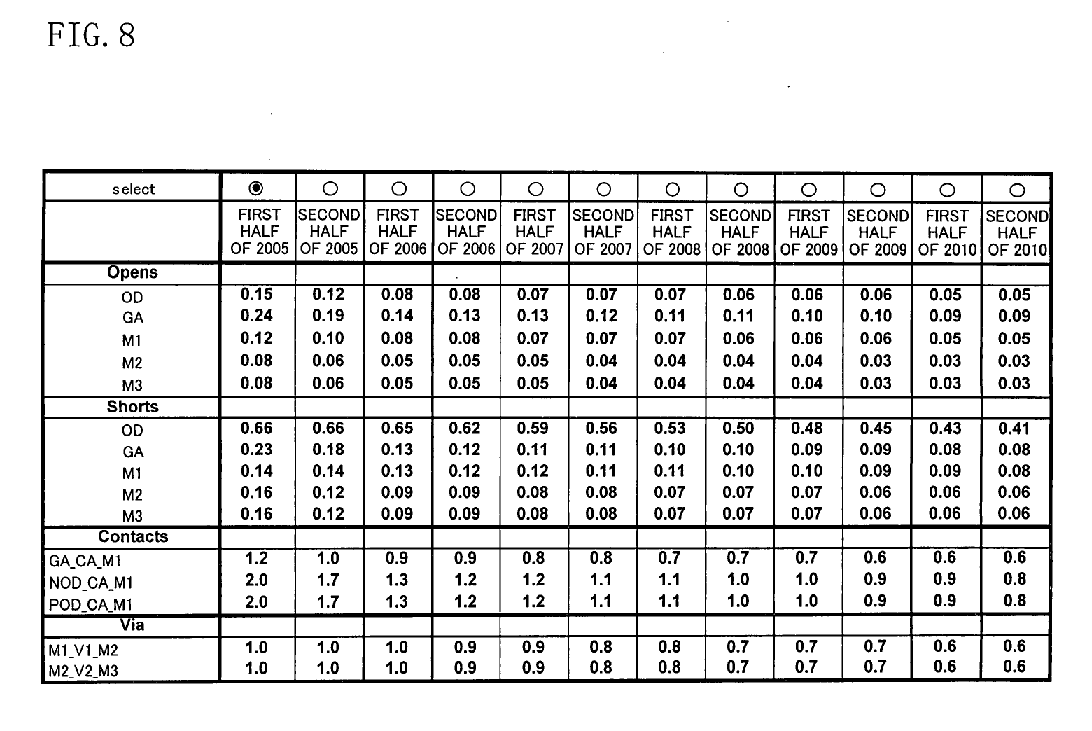

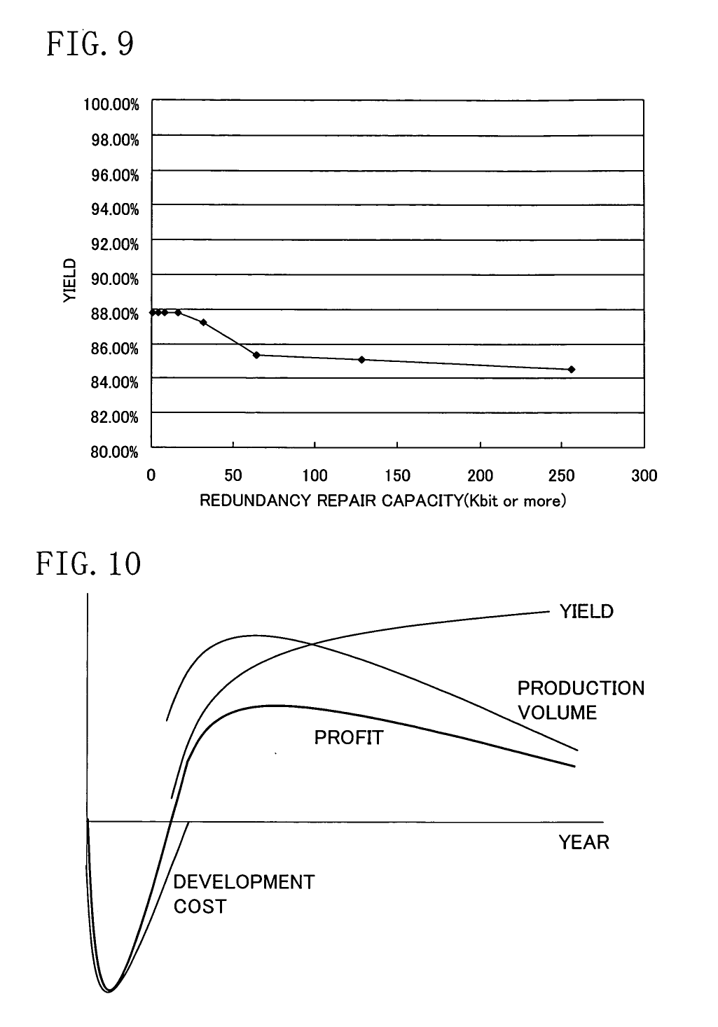

Furthermore, in this embodiment, a list of planned defect densities (D0 values) of respective plants and respective processes may be stored in the memory 202, and information 106 of test cost, the number of chips obtained from one wafer (hereinafter referred to as the obtained chip number) or chip cost (obtained by dividing cost per wafer by the obtained chip number) of the product type (target product) may be previously obtained to be stored in the memory 202. In this manner, in step S14, the yield of the target product at the beginning of the production or at another desired stage may be obtained correspondingly to each memory cell redundancy repair condition by using the calculation result 104, namely, the effective critical area values of the respective circuit elements and the respective layers of the target product, planned D0 values 105 of a production projected plant for the target product selected from the list of the planned defect densities (D0 values) of the respective plants and processes, and the information 106 of the test cost or the like. FIG. 8 shows an example of the planned D0 values 105 of the production planned plant for the target product. In FIG. 8, “Opens” indicates disconnection of interconnects, “Shorts” indicates interconnection short, “Contacts” indicates contact open or short, “Via” indicates via open or short, “OD” indicates an active region, “GA” indicates a gate electrode, “M” indicates an interconnect layer, “NOD” indicates an active region of an N-type MIS transistor, “POD” indicates an active region of a P-type MIS transistor and “V” indicates a via. Also, FIG. 9 shows an example of the yields of the target product (attained after performing the redundancy repair) corresponding to the respective redundancy repair conditions (specifically, redundancy repair capacities) obtained in the above-described method.

Furthermore, in step S14, the yields of the target product corresponding to the respective redundancy repair conditions obtained in the aforementioned manner are quantitatively and numerically evaluated together with “test time cost derived from the addition of the redundancy repair process”, “cost for performing the redundancy repair process” and “influence on the chip area or the obtained chip number caused by providing a redundancy repair circuit to the target product” all included in the information 106 of the test cost and the like. Thus, the most advantageous redundancy repair condition, for example, an SRAM that can be actually redundancy repaired can be determined.

Next, in step S15, the redundancy repair condition determined in step S14, the calculation result 104, namely, the effective critical area values of the respective circuit elements and the respective layers of the target product, and the planned D0 values 105 of the production projected plant for the target product (for example, D0 target values of respective processing in the mass production) are used to calculate a yield attained for a given period of time (for example, several years) from the start of the mass production, and on the basis of the thus calculated yield, the profitability is examined and the mass production schedule is determined. FIG. 10 shows an example of the result of the profitability examination in step S15.

As described so far, according to this embodiment, a critical area value, which is a parameter necessary for calculating a yield of a given semiconductor device product, can be estimated before starting actual design. Also, the critical area value can be used for accurately predicting, before starting the design of an actual semiconductor device product, the yield of the target product attained at a desired stage (for example, at a stage of mass production).

What is claimed is:

1. A critical area calculation method comprising a step of:
obtaining an effective critical area value of each circuit element of a target product on the basis of an effective critical area value per unit area or per unit capacity of each circuit element calculated beforehand and an area or capacity of each circuit element of said target product.

2. The critical area calculation method of claim 1,
wherein said effective critical area value per unit area or per unit capacity of each circuit element is obtained through critical area analysis of a circuit TEG or another product and is stored in a database.

3. A yield calculation method using the critical area calculation method of claim 1, comprising a step of calculating a yield of said target product by using said effective critical area value of each circuit element of said target product, a defect density to be obtained on a fabrication line for said target product and a given yield model.

4. The yield calculation method of claim 3,
wherein said target product has a memory cell macro including a memory cell portion, a peripheral circuit portion and a redundancy repair circuit portion for repairing a failure caused in said memory cell portion, and
said effective critical area value of each circuit element of said target product is obtained separately at least with respect to said memory cell portion and said peripheral circuit portion, and on the basis of said effective circuit area value thus obtained separately, a yield of said memory cell macro is obtained separately with respect to a case where redundancy repair is performed and a case where the redundancy repair is not performed.

5. A redundancy repair condition determining method by using the yield calculation method of claim 4, comprising the steps of:
calculating yields of said target product corresponding to redundancy repair conditions by using, as said defect density, a planned defect density to be attained in mass production of said target product; and
determining a redundancy repair condition in consideration of said calculated yields of said target product, test time cost derived from addition of redundancy repair processing, cost for performing said redundancy repair processing and influence on a chip area or obtained chip number caused by providing a redundancy repair circuit to said target product.

6. A method using the redundancy repair condition determining method of claim 5, comprising the steps of:
calculating a yield of said target product attained for a given period of time from start of mass production by using said determined redundancy repair condition, said effective critical area value of each circuit element of said target product and said planned defect density; and
examining profitability and determining mass production schedule on the basis of said calculated yield.
